(19) United States
(12) Patent Application Publication
(10) Pub. No.: US 2015/0101337 A1
(43) Pub. Date: Apr. 16, 2015

(54) NOZZLE ARRANGEMENT FOR AN ENGINE

(71) Applicant: Reaction Engines Ltd, Abingdon (GB)

(72) Inventors: Alan Bond, Abingdon (GB); Helen Webber, Abingdon (GB)

(21) Appl. No.: 14/296,628

(22) Filed: Jun. 5, 2014

(30) Foreign Application Priority Data
Oct. 11, 2013 (GB) 1318112.8

(51) Int. Cl. F02K 9/97; F02K 9/50

(52) U.S. Cl. CPC F02K 9/97; F02K 9/50
USPC 60/770

(57) ABSTRACT

A nozzle arrangement for an engine that is operable in both an air-breathing mode, in which the engine combusts air taken in from atmosphere with hydrogen from a store thereof, and in a rocket mode, in which the engine combusts oxygen from a store thereof with hydrogen from the store thereof. The nozzle arrangement may include a rocket combustion chamber fluidly coupled by a rocket throat to a rocket nozzle. The rocket nozzle includes a first portion adjacent the rocket throat and a second portion remote from the rocket throat and axially moveable relative to the first portion between a rocket position in which they form a substantially contiguous rocket nozzle and an air-breathing position in which they overlap to define an annular throat therebetween. The nozzle arrangement may also include at least one air-breathing combustion chamber arranged to be fluidly coupled to the annular throat when the first and second portions of the nozzle are in the air-breathing position.

### CROSS-REFERENCE TO RELATED APPLICATIONS

The present application claims priority under 35 U.S.C. §119(a) to the following application filed in the United Kingdom on Oct. 11, 2013, which is incorporated herein by reference: GB 1318112.8.

### FIELD

This invention relates the a nozzle arrangement for an engine that is operable in both an air-breathing mode and a rocket mode. In embodiments, the engine is for use in a single-stage-to-orbit spaceplane. Other applications are also envisaged.

### BACKGROUND

The SABRE engine being developed by Reaction Engines Limited of Oxfordshire, UK is an aircraft engine for powering applications such as a single-stage-to-orbit spaceplane. The engine is capable of operating both in an air-breathing mode and in a rocket mode. At lower altitudes, the engine operates in the air-breathing mode. In this mode, the engine operates by expanding an on-board store of gaseous helium contained in a closed loop through a turbine of a turbo-compressor to drive a compressor of the turbo-compressor to compressor intake atmospheric air. The compressed air is mixed with hydrogen from an on-board store of liquid hydrogen and the resulting mixture combusted and then exhausted to provide thrust. At high altitudes, the engine operates in the rocket mode. In this mode, instead of taking in atmospheric air, the engine mixes oxygen from an on-board store of liquid oxygen with the hydrogen, and combusts the mixture which is then exhausted to provide thrust. The turbo-compressor is not used in the rocket mode.

A problem exists in how to provide for combustion and exhaust in each of the two modes. One solution would be to provide separate combustion chambers and nozzles for each of the air-breathing mode and the rocket mode—that is a first combustion chamber and nozzle for use in air-breathing mode, and a separate combustion chamber and nozzle for use in rocket mode. However, this approach would bring with it significant weight and drag penalties, making it undesirable.

An alternative approach would be to provide a common combustion chamber and associated nozzle for use in both modes of operation. However, in order to provide thrust in the rocket mode, it would be necessary for the combustion chamber to be a rocket combustion chamber and for the oxygen and hydrogen to be combusted in the chamber and then expanded and exhausted through a rocket nozzle. However, such an arrangement is not optimised for operation in the air-breathing mode. The rocket engine combustion chamber would necessarily be designed for high pressure operation. As a result, when operating in the air-breathing mode, a compression ratio of intake atmospheric air of approximately 100:1 may be needed. It will be appreciated that this high compression ratio necessitates a high fuel flow rate of hydrogen. As a result, more hydrogen must be carried than would otherwise be the case, resulting in increased weight and reduced performance. This solution is therefore also undesirable.

It is therefore desirable to provide an arrangement that addresses these disadvantages.

### SUMMARY

According to a first aspect of this disclosure, there is provided a nozzle arrangement for an engine that is operable in both an air-breathing mode in which the engine combusts air taken in from atmosphere with hydrogen from a store thereof and in a rocket mode in which the engine combusts oxygen from a store thereof with hydrogen from the store thereof, the nozzle arrangement comprising a rocket combustion chamber fluidly coupled by a rocket throat to a rocket nozzle, the rocket nozzle comprising a first portion adjacent the rocket throat and a second portion remote from the rocket throat and axially moveable relative to the first portion between a rocket position in which they form a substantially contiguous rocket nozzle and an air-breathing position in which they overlap to define an annular throat therebetween, the nozzle arrangement further comprising at least one air-breathing combustion chamber arranged to be fluidly coupled to the annular throat when the first and second portions of the nozzle are in the air-breathing position.

By providing separate combustion chambers for each of the rocket mode and the air-breathing mode, but with a common nozzle, the significant weight and drag disadvantages of providing separate nozzles are avoided—the drag penalty of providing additional nozzles that are “dead” for are least part of atmospheric flight are considerable—while at the same time providing for separate combustion chambers that can be optimised for each of rocket combustion and air-breathing combustion. Furthermore, by providing a nozzle comprising two portions that can be overlapped to provide an annular throat for the air-breathing mode is a convenient solution to allowing the (at least one) air-breathing combustion chamber to share the same nozzle as the rocket combustion chamber. It has also been found that such an annular throat encourages—at least in some operating conditions—attached flow along the wall of the nozzle when in the air-breathing mode.

The first portion of the nozzle may be a substantially frusto-conical portion with a larger diameter end lying in a radial plane. The second portion may be a substantially frusto-conical portion with a smaller diameter end lying in a radial plane. The smaller diameter end of the second portion may comprise a substantially cylindrical portion extending substantially axially from a neck portion of the second portion. When in the rocket position, the larger diameter end of the first portion may engage the neck portion of the second portion to form the substantially contiguous rocket nozzle. The engagement may be substantially sealed engagement.

The rocket combustion chamber and the rocket throat may be fixed to, or fixed relative to, the first portion of the nozzle.

The at least one air-breathing combustion chamber may comprise a plurality of air-breathing combustion chambers, each arranged to be fluidly coupled to the annular throat when the first and second portions of the nozzle are in the air-breathing position. The air-breathing combustion chambers may be circumferentially distributed around the nozzle. They may be circumferentially distributed around the first portion of the nozzle. They may be distributed with substantially constant angular pitch. The at least one air-breathing combustion chamber may be fixed to, or relative to, the first portion of the nozzle.

The at least one air-breathing combustion chamber may be fluidly coupled to an annular throat via an annular plenum, the annular plenum being fluidly coupled to the annular throat when the first and second portions of the nozzle are in the air-breathing position. The annular plenum may surround the first portion of the nozzle. The annular plenum may be fixed to, or relative to, the first portion of the nozzle. The annular plenum may be arranged to provide sealed engagement between an exit of the annular plenum and an external surface of the first portion of the nozzle that is overlapped by the second portion of the nozzle when in the air-breathing position. The annular plenum may be arranged to engage the smaller diameter end of the second portion to provide sealed engagement between the exit of the annular plenum and an internal surface of the second portion of the nozzle when in the air-breathing position. The annular plenum may be arranged to engage the cylindrical portion of the smaller diameter end of the second portion to provide sealed engagement between the exit of the annular plenum and an internal surface of the second portion of the nozzle when in the air-breathing position. A flexible fluid-tight coupling may be provided between the annular plenum and the internal surface of the second portion of the nozzle that provides fluid-tight coupling therebetween while allowing relative movement. The flexible fluid-tight coupling may comprise a bellows arrangement.

The at least one air-breathing combustion chamber may comprise a single annular air-breathing combustion chamber that surrounds the first portion of the nozzle. The single air-breathing combustion chamber may be fixed to, or relative to, the first portion of the nozzle. The single air-breathing combustion chamber may be arranged to provide sealed engagement between an exit of the single air-breathing combustion chamber and an external surface of the first portion of the nozzle that is overlapped by the second portion of the nozzle when in the air-breathing position. The single air-breathing combustion chamber may be arranged to engage the smaller diameter end of the second portion to provide sealed engagement between the exit of the single air-breathing combustion chamber and an internal surface of the second portion of the nozzle when in the air-breathing position. The single air-breathing combustion chamber may be arranged to engage the cylindrical portion of the smaller diameter end of the second portion to provide sealed engagement between the exit of the annular plenum and an internal surface of the second portion of the nozzle when in the air-breathing position. A flexible fluid-tight coupling may be provided between the at least one air breathing combustion chamber and the internal surface of the second portion of the nozzle that provides fluid-tight coupling therebetween while allowing relative movement. The flexible fluid-tight coupling may comprise a bellows arrangement.

The at least one air-breathing combustion chamber may be arranged to receive compressed atmospheric air and hydrogen from the store thereof. The rocket combustion chamber may be arranged to receive oxygen and hydrogen each from a respective store thereof.

The geometry of the nozzle may be such that there is divergence in the annular throat between the overlapped first and second portion of the nozzle, when in the air-breathing mode.

It has been found that divergence in the annular throat results in better heat transfer characteristics in the area of the annular throat. In particular, it has been found that the amount of heat transfer in this area is less than for other annular throat geometries.

The divergence in the annular throat may be such that the ratio of the radial width of the throat at its outlet to the radial width of the throat at its inlet may be greater than 1:1 and less than 4:1. It may be greater than 1:1 and less than 3.5:1. It may be between 1.5:1 and 3.5:1. The throat may be defined as the area of overlap between the second portion and the first portion of the nozzle, with the position of the inlet and outlet defined accordingly.

The area ratio of the first portion of the nozzle, that is the ratio of the exit of the first portion to the rocket throat, may be between 20:1 and 50:1. It may be between 25:1 and 35:1. In an embodiment, it may be 30:1.

The area ratio of the substantially contiguous rocket nozzle that is formed in the rocket mode, that is the ratio of the exit of the second portion to the rocket throat, may be at least 100:1 in order to achieve desirable exhaust velocities. It may be between 110:1 and 130:1. In an embodiment, it may be 120:1.

The nozzle arrangement may comprise an actuator arrangement that is arranged to move the second portion of the nozzle between the two positions. The actuator arrangement may comprise at least one electromechanical actuator and/or at least one electrohydraulic actuator.

According to a second aspect of this disclosure, there is provided an engine operable in both an air-breathing mode in which the engine combusts air taken in from atmosphere with hydrogen from a store thereof and in a rocket mode in which the engine combusts oxygen from a store thereof with hydrogen from a store thereof, the engine comprising a plurality of nozzle arrangements, each nozzles arrangement comprising a rocket combustion chamber fluidly coupled by a rocket throat to a rocket nozzle, the rocket nozzle comprising a first portion adjacent and the throat and a second portion remote from the throat and axially moveable relative to the first portion between a rocket position in which they form a substantially contiguous rocket nozzle and an air-breathing position in which they overlap to define an annular throat therebetween, the nozzle arrangement further comprising at least one air-breathing combustion chamber arranged to be fluidly coupled to the annular throat when the first and second portions of the nozzle are in the air-breathing position.

Optional features of the first aspect are also optional features of the second aspect.

### BRIEF DESCRIPTION OF THE DRAWINGS

FIG. 1 shows a perspective view of four nozzle arrangements;

FIG. 2 shows a representative one of the nozzle arrangements in an air-breathing mode of operation; and

FIG. 3 shows the representative one of the nozzle arrangements in a rocket mode of operation.

### DETAILED DESCRIPTION

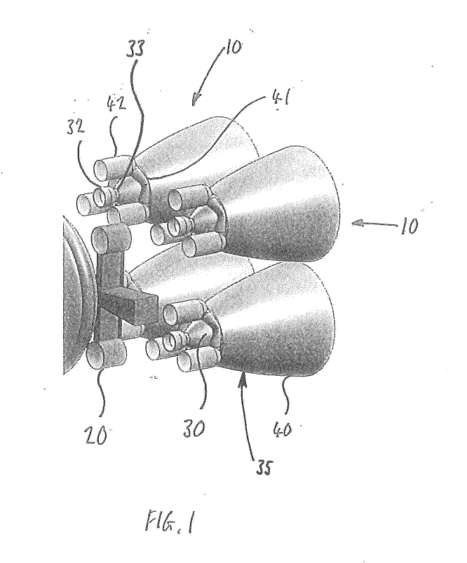

FIG. 1 shows part of an engine. One application of the engine would be to power a single-stage-to-orbit spaceplane. The engine is operable in two modes: an air-breathing mode in which air is drawn in from atmosphere and compressed using a turbo-compressor for combustion with an on-board store of liquid hydrogen; and a rocket mode in which no atmospheric air is drawn in and the hydrogen is combusted instead with oxygen from an on-board store.

With continued reference to FIG. 1, four nozzle arrangements 10 are shown. These are shown spatially arranged as they generally would be in the engine of which they form part. This four nozzle arrangements 10 are arranged in the most compact manner: in a two-by-two arrangement, such that the axis of each passes through a respective corner of the same square. Other components of the engine, such as a main structural member 20 against which the nozzle arrangements 10 react when providing thrust, are also shown.

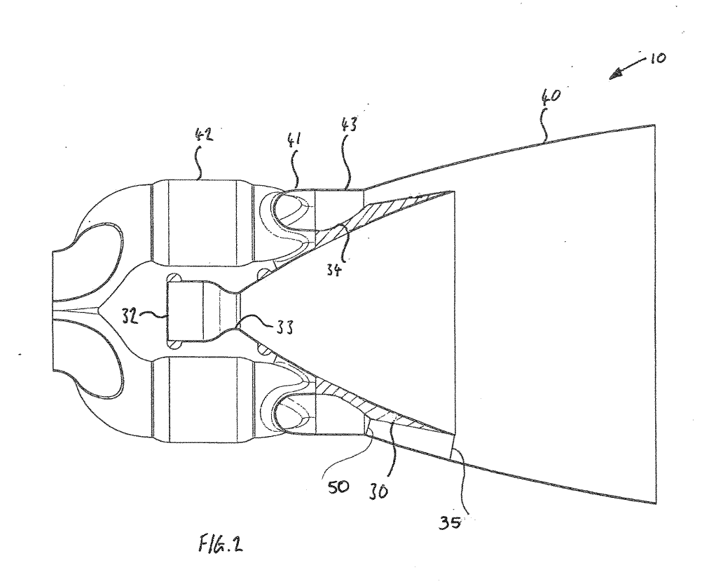

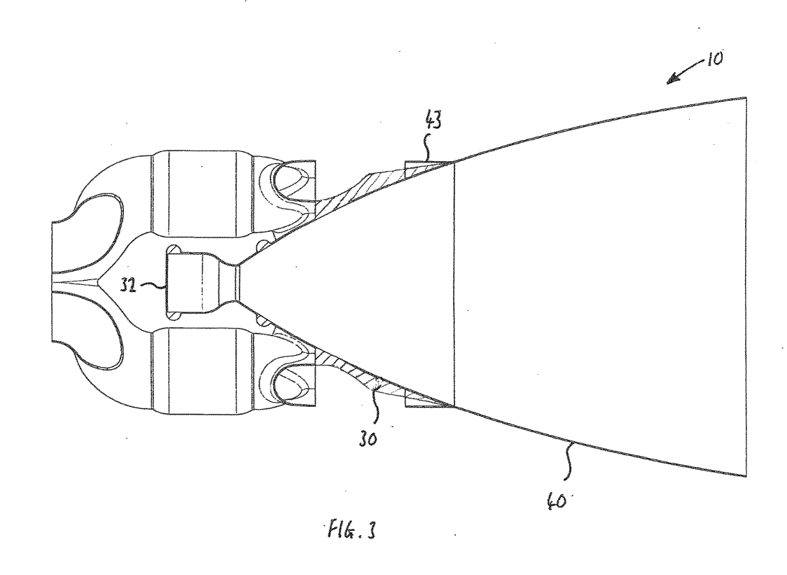

Each nozzle arrangement 10 has several components. For each, a rocket combustion chamber 32 is connected to and fluidly coupled to a rocket throat 33, which is connected to a fluidly coupled to a rocket nozzle 35. The rocket nozzle 35 is in two portions: a first nozzle portion 30, that is adjacent and connected to the rocket throat 33; and a second nozzle portion 40, that is adjacent the first portion 30 but separate from that portion. As will be understood from the description that follows, the two portions 30, 40 of the nozzle 35 are moveable relative to each other between two positions. In one position, which will be termed a “rocket position”, the two portions 30, 40 are positioned such that their interiors form a contiguous rocket nozzle. This position is used during the rocket mode of operation of the engine. In the other position, which will be termed the “air-breathing position”, the second portion 40 is moved axially relative to the remainder of the engine so as to partly overlap the larger diameter end of the first portion 30. This position is used during the air-breathing mode of operation, and is the arrangement shown in FIG. 1. The two positions will be explained further below with reference to FIG. 2 and FIG. 3.

With continued reference to FIG. 1, each nozzle arrangement 10 further comprises three air-breathing combustion chambers 42. These are arranged around the first portion of the nozzle 35 with constant angular pitch. Each of the air-breathing combustion chambers 42 is connected to and in fluid communication with an annular manifold in the form of a plenum 41. The plenum 41 extends around the first portion 30 of the nozzle 40 and is mounted to that first portion 30.

FIG. 2 shows the arrangement in more detail. This figure shows a representative one of the nozzles 10 in the air-breathing mode, in which the second portion 40 of the nozzle 10 is in the air-breathing position in which it can be seen to partly overlap the first portion 30 and the larger diameter end of that portion 30. As can be seen, the plenum 41, which is shown in section, forms an exhaust manifold for the three air-breathing combustion chambers 42.

Each of the first and second portions of the nozzle 10 is generally frusto-conical. The smaller diameter end of the second portion 40 of the nozzle 10, however, additionally comprises a cylindrical section 43 that is coaxial with the remainder of the nozzle 10. The cylindrical section is such that it engages with a radially outer circumferential edge of the plenum 41 in a manner that is substantially sealed when the second portion 40 is in this position. The outer surface of the first portion 30 of the nozzle 10 has a shoulder portion 34 that engages with a radially inner circumferential edge of the plenum 41 in a manner that is substantially sealed. As the first portion 30 of the nozzle 10 does not move relative to the plenum 41 (or indeed all other described components save for the second portion 40), this engagement is permanent during operation. Together, the inside of the cylindrical section 43 and the outside of the shoulder portion 34 provide an annular flow passageway of substantially constant cross-section that is in flow communication with the plenum 41. In an alternative embodiment, the cylindrical section does not form part of the second portion 40, but instead is attached to and forms part of the plenum 41. It will be understood that this is an alternative way of providing, in effect, the same result.

The overlap between the two portions 30, 40 of the nozzle 10 creates an annular throat 50 around the outside of the larger diameter end of the first nozzle portion 30 and the inside of the smaller diameter end of the second nozzle portion 40. The annular throat 50 is in fluid communication with the annular flow passageway between the cylindrical section 43 and the shoulder portion 34. Although omitted from FIG. 2 and FIG. 3 for simplicity of illustration, the geometry of the first 30 and second 40 portions of the nozzle 10 is such that the annular throat 50 is diverging. In other words, the cross-sectional area of the annular throat increases along the axis away from the combustion chambers 42. It has been found that divergence in the annular throat results in better heat transfer characteristics in the area of the annular throat. In particular, it has been found that the heat transfer in this area is in the form of a spike adjacent the entrance to the annular throat that does not extend very far along the axial length of the annular throat 50. This is to be contrasted with an annular throat with a more constant cross-sectional area in which it has been found that the heat transfer is high along much more of the axial length. It is therefore much easier to provide for effective cooling of the annular throat region if it is designed with a diverging geometry. It will be understood that effective cooling is a very important consideration in the design of nozzles arrangements such that at of the present embodiment as it can impact greatly on safety, maintenance cost and useful life of the arrangement.

FIG. 3 shows a representative one of the nozzles 10 in the rocket mode. In this mode, the second nozzle portion 40 is positioned in the rocket position. In this position, the second nozzle portion 40 is positioned relative to the inner nozzle portion 30 such that the annular throat 50 is closed. In other words, the second nozzle portion 40 is translated to the right in FIG. 3 relative to the first nozzle portion 30. This is such that the generally frusto-conical sections of the two nozzle portions 30, 40 no longer overlap and instead form a contiguous diverging rocket nozzle similar in shape to a conventional rocket nozzle (although it will be noted that the cylindrical section 43 of the second portion 40 still overlaps the first portion 30).

During proof-of-concept modelling, various geometries were modelled with the resulting cold-flow performance shown in Table 1. In this table, AR is the area ratio of the exit of the first portion 30 of the nozzle 10 to the rocket throat 33, and E is the ratio of the cross-sectional area of the annular flow passage exit 35 to the cross-sectional area of the annular throat 50 (ratio E preferably being greater than 1:1 and less than 4:1). The rows show the results for nozzles with different values of E and AR. The columns show the results for those different nozzles at different atmospheric pressures, which correspond to different altitudes of operation. The letters in the cells have the following meaning:

First letter:
A: Fully attached flow
S: Separated flow

Second Letter:
O: Wake remains open
C: Wake closes

Third Letter:
S: There is recompression (i.e. a shock) along the walls
N: There is no shock

TABLE 1
Cold Flow Performance

| Nozzle/P_{amb} (bar) | 1 | 0.9 | 0.8 | 0.7 | 0.6 | 0.5 | 0.4 | 0.3 | 0.2 | 0.1 |
|---|---|---|---|---|---|---|---|---|---|---|
| AR = 20, E = 1 | SON | SON | SON | SCN | SCN | SCN | SCN | SCN | SCN | ACN |
| AR = 20, E = 1.5 | AOS | AOS | AOS | AOS | SCN | SCN | SCN | SCN | SCN | ACN |
| AR = 20, E = 2 | AOS | AOS | AOS | AOS | AOS | SCN | SCN | SCN | SCN | ACN |
| AR = 20, E = 3 | AOS | AOS | SOS | SOS | AOS | AOS | SON | SCN | ACN | ACN |
| AR = 20, E = 3.5 | SOS | AOS | AOS | AOS | AOS | SON | SON | ACN | ACN | ACN |
| AR = 50, E = 1 | AOS | AOS | SON | SON | SON | SON | SCN | SCN | SCN | ACN |
| AR = 50, E = 1.5 | AOS | AOS | AOS | SON | SON | SON | SON | SCN | SCN | ACN |
| AR = 50, E = 2 | AOS | AOS | AOS | AOS | SON | SON | SON | SCN | ACN | ACN |
| AR = 50, E = 3 | AOS | AOS | AOS | AOS | AOS | SON | SON | AON | ACN | ACN |
| AR = 50, E = 3.5 | AOS | AOS | AOS | AOS | AOS | SON | AON | AON | ACN | ACN |

These results suggest that higher AR and E are desirable in minimising separation and (as is described elsewhere in this disclosure) having E greater than 1 such that there is divergence in the annular throat can improve heat transfer characteristics. It is envisaged that, in other embodiments, any of the geometries shown in Table 1 may be used. Thus, it is envisaged, for example, that AR may be in the range of 20 to 50. However, as having an area ratio greater than about 30:1 can lead to engineering problems in relation to the amount of retraction that is needed of the second portion 40 of the nozzle 10 relative to the first portion 30, in the present embodiment, an area ratio of 30:1 is chosen.

In this embodiment, the overall area ratio of the rocket nozzle, that of the exit of the second portion 40 to the rocket throat 33 is chosen as being 120:1. Again, other ratios are envisaged and possible in other embodiments. For example, a ratio of at least 100:1 is envisaged.

In this embodiment, E is selected as being 2.0. Again, other values of E are envisaged and possible in other embodiments. For example, it is envisaged that E be in the range of 1 to 3.5, or 1 to 4.

In operation, and with reference to FIG. 2, the engine would usually start in the air-breathing mode for take-off and continue in this mode during lower altitude operation. Compressed atmospheric air is delivered to each of the three air-breathing combustion chambers 42 where it is mixed with hydrogen from the on-board store and combusted. The products of combustion flow from the combustion chambers 42 to the annular plenum 41, and from the annular plenum 41 between the cylindrical section 43 and the shoulder portion 34 to the annular throat 50. The combustion products are expanded somewhat along the axial length of the annular throat 50 and pass from there into the remainder of the second portion 40 of the nozzle 10 before exiting that portion 40 and the nozzle 10 altogether. It has also been found that an annular throat encourages—at least in some operating conditions—attached flow along the wall of the nozzle when in the air-breathing mode. This is not necessarily the case for all altitudes of operation, but it amounts to a further benefit of the annular throat, irrespective of whether the annular throat is diverging. Accordingly, in some embodiments, then annular throat may not diverge and may the other geometries.

With reference to FIG. 3, at higher altitudes where the atmosphere becomes rarefied, the engine transitions to the rocket mode of operation. This involves actuators (not shown) being operated to translate axially the second portion 40 of the nozzle 10 into the rocket position. In this configuration, no air is taken in from the atmosphere; instead, oxygen from the on-board store and hydrogen from the on-board store are mixed and combusted in the rocket combustion chamber 32 in a conventional manner, with the products of that combustion undergoing expansion and exhaust in what is now in effect a contiguous and conventional rocket nozzle.

As has already been mentioned, by providing separate combustion chambers for each of the rocket mode and the air-breathing mode, but with a common nozzle, the significant weight and drag disadvantages of providing separate nozzles are avoided—the drag penalty of providing additional nozzles that are “dead” for are least part of atmospheric flight are considerable—while at the same time providing for separate combustion chambers that can be optimised for each of rocket combustion and air-breathing combustion. Furthermore, providing a nozzle comprising two portions that can be overlapped to provide an annular throat for the air-breathing mode is a convenient solution to allowing the air-breathing combustion chambers to share the same nozzle as the rocket combustion chamber.

1. A nozzle arrangement for an engine that is operable in both an air-breathing mode in which the engine combusts air taken in from atmosphere with hydrogen from a store thereof and in a rocket mode in which the engine combusts oxygen from a store thereof with hydrogen from the store thereof, the nozzle arrangement comprising:
a rocket nozzle;
a rocket combustion chamber fluidly coupled by a rocket throat to the rocket nozzle, the rocket nozzle comprising a first portion adjacent to the rocket throat and a second portion remote from the rocket throat, and the second portion axially moveable relative to the first portion between a rocket position in which the first and second portions form a substantially contiguous rocket nozzle and an air-breathing position in which they overlap to define an annular throat therebetween, wherein the first portion of the rocket nozzle is a substantially frusto-conical portion with a larger diameter end lying in a radial plane and the second portion is a substantially frusto-conical portion with a smaller diameter end lying in a radial plane, with the smaller diameter end of the second portion comprising a substantially cylindrical portion extending substantially axially from a neck portion of the second portion; and when in the rocket position, the larger diameter end of the first portion engaging the neck portion of the second portion to form the substantially contiguous rocket nozzle in a substantially sealed engagement; and
at least one air-breathing combustion chamber arranged to be fluidly coupled to the annular throat when the first and second portions of the rocket nozzle are in the air-breathing position.

2. A nozzle arrangement according to claim 1, wherein the at least one air-breathing combustion chamber comprises a plurality of air-breathing combustion chambers, each arranged to be fluidly coupled to the annular throat when the first and second portions of the nozzle are in the air-breathing position.

3. A nozzle arrangement according to claim 1, wherein, the air-breathing combustion chambers are circumferentially distributed around the nozzle.

4. A nozzle arrangement according to claim 3, wherein the air-breathing combustion chambers are circumferentially distributed around the first portion of the nozzle.

5. A nozzle arrangement according to claim 1, wherein the at least one air-breathing combustion chamber is fixed to, or relative to, the first portion of the nozzle.

6. A nozzle arrangement according to claim 1, wherein the at least one air-breathing combustion chamber is fluidly coupled to the annular throat via an annular plenum, the annular plenum being fluidly coupled to the annular throat when the first and second portions of the nozzle are in the air-breathing position.

7. A nozzle arrangement according to claim 6, wherein the annular plenum surrounds the first portion of the nozzle.

8. A nozzle arrangement according to claim 6, wherein the annular plenum is fixed to, or relative to, the first portion of the nozzle.

9. A nozzle arrangement according to claim 6, wherein the annular plenum is arranged to provide sealed engagement between an exit of the annular plenum and an external surface of the first portion of the nozzle that is overlapped by the second portion of the nozzle when in the air-breathing position.

10. A nozzle arrangement according to claim 6, wherein the annular plenum is arranged to engage a smaller diameter end of the second portion to provide sealed engagement between the exit of the annular plenum and an internal surface of the second portion of the nozzle when in the air-breathing position.

11. A nozzle arrangement according to claim 6, wherein the smaller diameter end of the second portion of the nozzle comprises a substantially cylindrical portion extending substantially axially from a neck portion of the second portion, the annular plenum arranged to engage the cylindrical portion to provide sealed engagement between the exit of the annular plenum and an internal surface of the second portion of the nozzle when in the air-breathing position.

12. A nozzle arrangement according to claim 1, wherein the at least one air-breathing combustion chamber comprises a single annular air-breathing combustion chamber that surrounds the first portion of the nozzle.

13. A nozzle arrangement according to claim 12, wherein the single air-breathing combustion chamber is fixed to, or relative to, the first portion of the nozzle.

14. A nozzle arrangement according to claim 6, wherein the single air-breathing combustion chamber is arranged to provide sealed engagement between an exit of the single air-breathing combustion chamber and an external surface of the first portion of the nozzle that is overlapped by the second portion of the nozzle when in the air-breathing position.

15. A nozzle arrangement according to claim 6, wherein the single air-breathing combustion chamber is arranged to engage a smaller diameter end of the second portion to provide sealed engagement between the exit of the single air-breathing combustion chamber and an internal surface of the second portion of the nozzle when in the air-breathing position.

16. A nozzle arrangement according to claim 6, wherein the smaller diameter end of the second portion of the nozzle comprises a substantially cylindrical portion extending substantially axially from a neck portion of the second portion, the single air-breathing combustion chamber arranged to engage the cylindrical portion to provide sealed engagement between the exit of the single air-breathing combustion chamber and an internal surface of the second portion of the nozzle when in the air-breathing position.

17. A nozzle arrangement according to claim 1, wherein in the air-breathing mode, there is a divergence in the annular passage between the overlapped first and second portion of the nozzle.

18. A nozzle arrangement according to claim 17, wherein the divergence in the annular passage is such that the ratio of the cross-sectional area of the annular flow passage exit to the cross-sectional area of the annular throat is greater than 1:1 and less than 4:1.

19. A nozzle arrangement according to claim 1, further comprising an actuator arrangement that is arranged to move the second portion of the nozzle between the two positions.
